(19) United States
(12) Patent Application Publication
(10) Pub. No.: US 2021/0264284 A1
(43) Pub. Date: Aug. 26, 2021

(54) DYNAMICALLY ROUTED PATCH DISCRIMINATOR

(71) Applicant: Ford Global Technologies, LLC, Dearborn, MI (US)

(72) Inventors: Shubh Gupta, Fremont, CA (US); Nikita Jaipuria, Union City, CA (US); Praveen Narayanan, San Jose, CA (US); Vidya Nariyambut Murali, Sunnyvale, CA (US)

(73) Assignee: Ford Global Technologies, LLC, Dearborn, MI (US)

(21) Appl. No.: 16/800,950

(22) Filed: Feb. 25, 2020

(51) Int. Cl. G06N 3/08; G06N 3/04

(52) U.S. Cl. CPC G06N 3/088; G06N 3/0454

(57) ABSTRACT

The present disclosure discloses a system and a method. In an example implantation, the system and the method can generate, at a discriminator, a plurality of image patches from an image, determine a plurality of routing coefficients within a capsule network based on the plurality of image patches, generate a prediction indicating whether the image is synthetic or sourced from a real distribution based on the plurality of routing coefficients, and update one or more weights of a generator based on the prediction, wherein the generator is connected to the discriminator.

### BACKGROUND

Deep neural networks (DNNs) can be used to perform many image understanding tasks, including classification, segmentation, and captioning. For example, convolutional neural networks can take an image as input, assign an importance to various aspects/objects depicted within the image, and differentiate the aspects/objects from one another.

### BRIEF DESCRIPTION OF THE DRAWINGS

FIG. 1 is a diagram of an example system including a vehicle.

FIG. 2 is a diagram of an example server within the system.

FIG. 3 is a diagram of an example adversarial network.

FIG. 4 is a diagram of an example deep neural network.

FIG. 5 is a diagram of an example discriminator of the adversarial network.

FIG. 6 is an example image and image patches of the extracted from the image.

FIG. 7 is a flow diagram illustrating an example process for computing a context of image patches.

FIG. 8 is a flow diagram illustrating an example process for generating a prediction, of e.g., classifying, whether the input image is a synthetic image or an image sourced from a real distribution.

### DETAILED DESCRIPTION

A system comprises a computer including a processor and a memory, and the memory including instructions such that the processor is programmed to generate, at a discriminator, a plurality of image patches from an image, determine a plurality of routing coefficients within a capsule network based on the plurality of image patches, generate a prediction indicating whether the image is synthetic or sourced from a real distribution based on the plurality of routing coefficients, and update one or more weights of a generator based on the prediction, wherein the generator is connected to the discriminator.

In other features, the image is generated by the generator.

In other features, the image is based on a simulated image.

In other features, the simulated image is generated by a gaming engine.

In other features, the simulated image depicts a plurality of objects.

In other features, the image depicts the plurality of objects corresponding to an image view of the simulated image.

In other features, each routing coefficient of the plurality of routing coefficients corresponds to routes between capsule layers of the capsule network.

A system comprises a computer including a processor and a memory, and the memory including instructions such that the processor is programmed to generate, at a discriminator, a plurality of image patches from a synthetic image, determine a plurality of routing coefficients within a capsule network based on the plurality of image patches, generate a predicition indicating whether the synthetic image is synthetic or sourced from a real distribution based on the plurality of routing coefficients, update one or more weights of a generator based on the prediction, wherein the generator is connected to the discriminator.

In other features, the synthetic image is generated by the generator.

In other features, the image is based on a simulated image.

In other features, the simulated image is generated by a gaming engine.

In other features, the simulated image depicts a plurality of objects.

In other features, the image depicts the plurality of objects corresponding to an image view of the simulated image.

In other features, each routing coefficient of the plurality of routing coefficients corresponds to routes between capsule layers of the capsule network.

A method comprises generating, at a discriminator, a plurality of image patches from an image, determining a plurality of routing coefficients within a capsule network based on the plurality of image patches, generating a prediction indicating whether the image is synthetic or sourced from a real distribution based on the plurality of routing coefficients, and updating one or more weights of a generator based on the prediction, wherein the generator is connected to the discriminator.

In other features, the method further comprises generating the image at the generator.

In other features, the image is based on a simulated image.

In other features, the simulated image is generated by a gaming engine.

In other features, the simulated image depicts a plurality of objects.

In other features, each routing coefficient of the plurality of routing coefficients corresponds to routes between capsule layers of the capsule network.

Autonomous vehicles typically employ perception algorithms, or agents, to perceive the environment around the vehicle. However, training the perception algorithms typically requires large amounts of data. Gaming engines can be used to simulate data, such as synthetic images, that depict objects of interest to the perception algorithms. The objects of interest may include other vehicles, trailers, pedestrians, street markings, signs, or the like. However, the synthetic data may not appear “real.” As a result, the training of perception algorithms using synthetic data may not correspond to the training of perception algorithms using real, i.e., non-generated, data.

In some instances, generative adversarial networks (GANs) are used to transform simulated data to appear more photorealistic. However, the position, size, and/or shape of the objects within the simulated data are not preserved during transformation, which can render ground truth labels generated from simulation unusable for training purposes.

The present disclosure discloses an adversarial neural network that includes a discriminator that extracts, e.g., generates, image patches from an input image. The discriminator can then compute a context of the image patches. For example, a context refers to as a weighted combination of individual image patches. The weights for the weighted combination can be determined by a capsule neural network. Using the computed context, the discriminator classifies whether the computed context corresponds to a synthetic image or an image sourced from a real distribution.

While the present disclosure describes a vehicle system and a server, it is understood that any suitable computer system may be used to perform the techniques and/or the functionality of the adversarial neural network described herein. The discriminator can be used to adversarially train the generator such that a trained generator can generate photorealistic synthetic data. The photorealistic synthetic data can be used for training and validating deep neural networks for image perception tasks, such as image classification and the like.

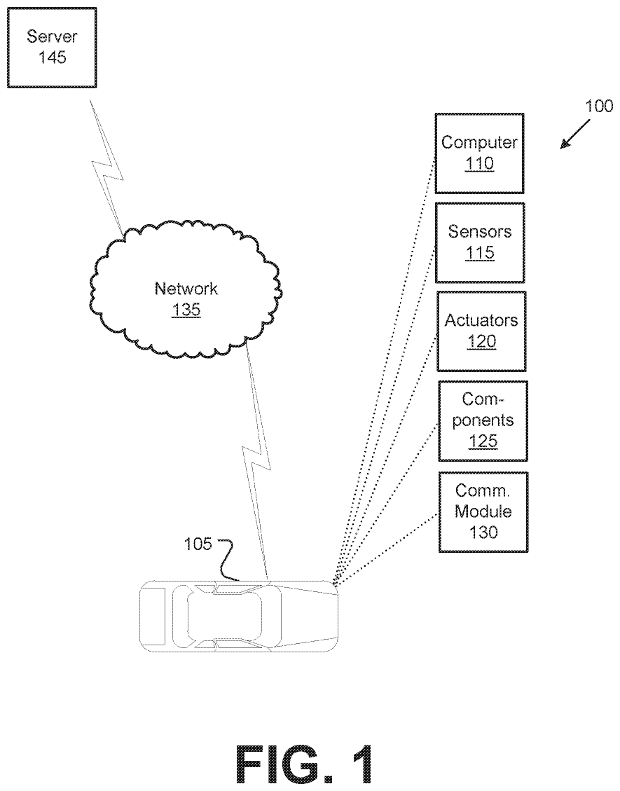

FIG. 1 is a block diagram of an example vehicle system 100. The system 100 includes a vehicle 105, which is a land vehicle such as a car, truck, etc. The vehicle 105 includes a computer 110, vehicle sensors 115, actuators 120 to actuate various vehicle components 125, and a vehicle communications module 130. Via a network 135, the communications module 130 allows the computer 110 to communicate with a server 145.

The computer 110 includes a processor and a memory. The memory includes one or more forms of computer-readable media, and stores instructions executable by the computer 110 for performing various operations, including as disclosed herein.

The computer 110 may operate a vehicle 105 in an autonomous, a semi-autonomous mode, or a non-autonomous (manual) mode. For purposes of this disclosure, an autonomous mode is defined as one in which each of vehicle 105 propulsion, braking, and steering are controlled by the computer 110; in a semi-autonomous mode the computer 110 controls one or two of vehicles 105 propulsion, braking, and steering; in a non-autonomous mode a human operator controls each of vehicle 105 propulsion, braking, and steering.

The computer 110 may include programming to operate one or more of vehicle 105 brakes, propulsion (e.g., control of acceleration in the vehicle by controlling one or more of an internal combustion engine, electric motor, hybrid engine, etc.), steering, climate control, interior and/or exterior lights, etc., as well as to determine whether and when the computer 110, as opposed to a human operator, is to control such operations. Additionally, the computer 110 may be programmed to determine whether and when a human operator is to control such operations.

The computer 110 may include or be communicatively coupled to, e.g., via the vehicle 105 communications module 130 as described further below, more than one processor, e.g., included in electronic controller units (ECUs) or the like included in the vehicle 105 for monitoring and/or controlling various vehicle components 125, e.g., a powertrain controller, a brake controller, a steering controller, etc. Further, the computer 110 may communicate, via the vehicle 105 communications module 130, with a navigation system that uses the Global Position System (GPS). As an example, the computer 110 may request and receive location data of the vehicle 105. The location data may be in a known form, e.g., geo-coordinates (latitudinal and longitudinal coordinates).

The computer 110 is generally arranged for communications on the vehicle 105 communications module 130 and also with a vehicle 105 internal wired and/or wireless network, e.g., a bus or the like in the vehicle 105 such as a controller area network (CAN) or the like, and/or other wired and/or wireless mechanisms.

Via the vehicle 105 communications network, the computer 110 may transmit messages to various devices in the vehicle 105 and/or receive messages from the various devices, e.g., vehicle sensors 115, actuators 120, vehicle components 125, a human machine interface (HMI), etc. Alternatively or additionally, in cases where the computer 110 actually comprises a plurality of devices, the vehicle 105 communications network may be used for communications between devices represented as the computer 110 in this disclosure. Further, as mentioned below, various controllers and/or vehicle sensors 115 may provide data to the computer 110.

Vehicle sensors 115 may include a variety of devices such as are known to provide data to the computer 110. For example, the vehicle sensors 115 may include Light Detection and Ranging (lidar) sensor(s) 115, etc., disposed on a top of the vehicle 105, behind a vehicle 105 front windshield, around the vehicle 105, etc., that provide relative locations, sizes, and shapes of objects and/or conditions surrounding the vehicle 105. As another example, one or more radar sensors 115 fixed to vehicle 105 bumpers may provide data to provide and range velocity of objects (possibly including second vehicles), etc., relative to the location of the vehicle 105. The vehicle sensors 115 may further include camera sensor(s) 115, e.g. front view, side view, rear view, etc., providing images from a field of view inside and/or outside the vehicle 105.

The vehicle 105 actuators 120 are implemented via circuits, chips, motors, or other electronic and or mechanical components that can actuate various vehicle subsystems in accordance with appropriate control signals as is known. The actuators 120 may be used to control components 125, including braking, acceleration, and steering of a vehicle 105.

In the context of the present disclosure, a vehicle component 125 is one or more hardware components adapted to perform a mechanical or electro-mechanical function or operation—such as moving the vehicle 105, slowing or stopping the vehicle 105, steering the vehicle 105, etc. Non-limiting examples of components 125 include a propulsion component (that includes, e.g., an internal combustion engine and/or an electric motor, etc.), a transmission component, a steering component (e.g., that may include one or more of a steering wheel, a steering rack, etc.), a brake component (as described below), a park assist component, an adaptive cruise control component, an adaptive steering component, a movable seat, etc.

In addition, the computer 110 may be configured for communicating via a vehicle-to-vehicle communication module or interface 130 with devices outside of the vehicle 105, e.g., through a vehicle-to-vehicle (V2V) or vehicle-to-infrastructure (V2X) wireless communications to another vehicle, to (typically via the network 135) a remote server 145. The module 130 could include one or more mechanisms by which the computer 110 may communicate, including any desired combination of wireless (e.g., cellular, wireless, satellite, microwave and radio frequency) communication mechanisms and any desired network topology (or topologies when a plurality of communication mechanisms are utilized). Exemplary communications provided via the module 130 include cellular, Bluetooth®, IEEE 802.11, dedicated short range communications (DSRC), and/or wide area networks (WAN), including the Internet, providing data communication services.

The network 135 can be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth, Bluetooth Low Energy (BLE), IEEE 802.11, vehicle-to-vehicle (V2V) such as Dedicated Short-Range Communications (DSRC), etc.), local area networks (LAN) and/or wide area networks (WAN), including the Internet, providing data communication services.

A computer 110 can receive and analyze data from sensors 115 substantially continuously, periodically, and/or when instructed by a server 145, etc. Further, object classification or identification techniques can be used, e.g., in a computer 110 based on lidar sensor 115, camera sensor 115, etc., data, to identify a type of object, e.g., vehicle, person, rock, pothole, bicycle, motorcycle, etc., as well as physical features of objects.

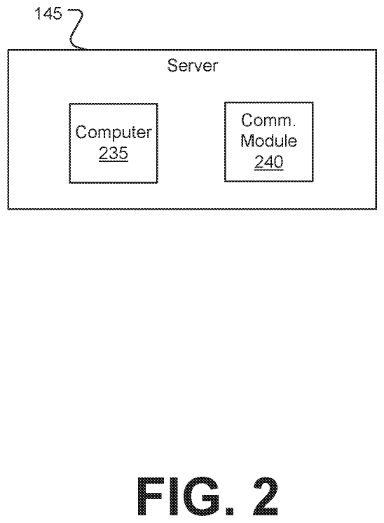

FIG. 2 is a block diagram of an example server 145. The server 145 includes a computer 235 and a communications module 240. The computer 235 includes a processor and a memory. The memory includes one or more forms of computer-readable media, and stores instructions executable by the computer 235 for performing various operations, including as disclosed herein. The communications module 240 allows the computer 235 to communicate with other devices, such as the vehicle 105.

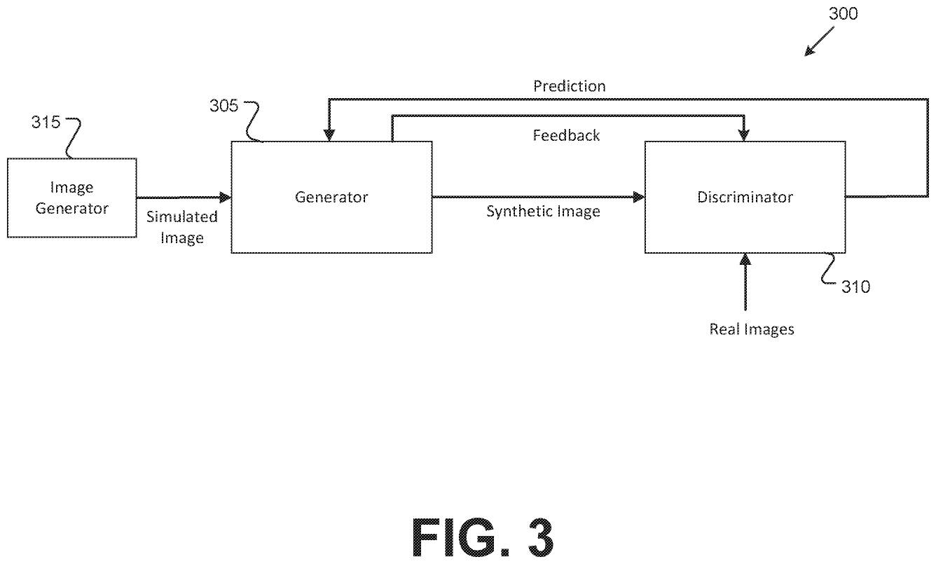

FIG. 3 is a diagram of an example adversarial neural network 300. The adversarial neural network 300 can be a software program that can be loaded in memory and executed by a processor in the vehicle 105 and/or the server 145, for example. As shown, the adversarial neural network 300 includes a generator 305 and a discriminator 310. Within the present context, the generator 305 and the discriminator 310 comprise a generative adversarial network (GAN). The GAN is a deep neural network that employs a class of artificial intelligence algorithms used in machine learning and implemented by a system of two neural networks contesting each other in an adversarial zero-sum game framework.

In an example implementation, the generator 305 receives a synthetic input image. The synthetic input image can be generated by a synthetic image generator 315. In an example implementation, the image generator 315 comprises a gaming engine. The input images may correspond based on the objects, image views, and/or parameters of the objects depicted in the images. For example, if the synthetic input image is a plan view of a vehicle trailer, the corresponding input image is plan view of a vehicle trailer.

The generator 305 generates a synthetic image based on the synthetic input image. For instance, the generator 305 receives a simulated red-green-blue (RGB) image including one or more features or objects depicted in the input images. Within the present context, the synthetic image may be an image-to-image translation of the simulated image, e.g., the input image is translated from one domain (simulation) to another domain (real). In one or more implementations, the generator 305 may comprise an encoder-decoder neural network. However, it is understood that other neural networks may be used in accordance with the present disclosure.

The discriminator 310 is configured to receive an image, evaluate the received image, and generate a prediction indicative of whether the received image is machine-generated by the generator 305 or is sourced from a real data distribution. The discriminator 310 receives synthetic images generated by the generator 305 and images from a real data distribution during training such that the discriminator 310 can distinguish between synthetic images and images from a real data distribution. In one or more implementations, the discriminator 310 may comprise a convolutional neural network. However, it is understood that other neural networks may be used in accordance with the present disclosure.

The training of the generator 305 may use reinforcement learning to train the generative model. Reinforcement learning is a type of dynamic programming that trains algorithms using a system of reward and punishment. A reinforcement learning algorithm, or reinforcement learning agent, learns by interacting with its environment. The agent receives rewards by performing correctly and penalties for performing incorrectly. For instance, the reinforcement learning agent learns without intervention from a human by maximizing the reward and minimizing the penalty.

As shown in FIG. 3, the prediction is provided to the generator 305. The generator 305 can use the prediction to modify, i.e., update, one or more weights of the generator 305 to minimize the predictions indicating the generated synthetic image is classified as synthetic, i.e., fake. For example, the generator 305 may update one or more weights within the generator 305 using backpropagation, or the like.

The discriminator 310 can also be updated based on the prediction. For example, if the prediction indicates the generated synthetic image is from a real data distribution, the discriminator 310 may receive feedback indicating the image is a synthetic image. Based on the feedback, one or more weights of the discriminator 310 can be updated to minimize incorrect predictions. Through the training process, the generator 305 can improve the quality of synthetic images generated, e.g., generate more realistic synthetic images, and the discriminator 310 can improve identification of nuances and characteristics of synthetically generated images.

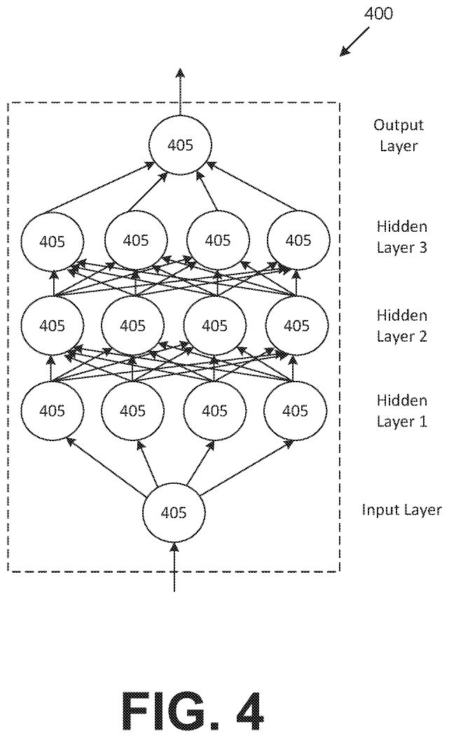

FIG. 4 is a diagram of an example deep neural network (DNN) 400. The DNN 400 may be representative of the generator 305 and/or the discriminator 310 described above. The DNN 400 includes multiple nodes 405, and the nodes 405 are arranged so that the DNN 400 includes an input layer, one or more hidden layers, and an output layer. Each layer of the DNN 400 can include a plurality of nodes 405. While FIG. 4 illustrates three (3) hidden layers, it is understood that the DNN 400 can include additional or fewer hidden layers. The input and output layers may also include more than one (1) node 405.

The nodes 405 are sometimes referred to as artificial neurons 405, because they are designed to emulate biological, e.g., human, neurons. A set of inputs (represented by the arrows) to each neuron 405 are each multiplied by respective weights. The weighted inputs can then be summed in an input function to provide, possibly adjusted by a bias, a net input. The net input can then be provided to activation function, which in turn provides a connected neuron 405 an output. The activation function can be a variety of suitable functions, typically selected based on empirical analysis. As illustrated by the arrows in FIG. 4, neuron 405 outputs can then be provided for inclusion in a set of inputs to one or more neurons 405 in a next layer.

The DNN 400 can be trained to accept data as input and generate an output based on the input. The DNN 400 can be trained with ground truth data, i.e., data about a real-world condition or state. For example, the DNN 400 can be trained with ground truth data or updated with additional data by a processor. Weights can be initialized by using a Gaussian distribution, for example, and a bias for each node 405 can be set to zero. Training the DNN 400 can including updating weights and biases via suitable techniques such as backpropagation with optimizations. Ground truth data can include, but is not limited to, data specifying objects within an image or data specifying a physical parameter, e.g., angle, speed, distance, or angle of object relative to another object. For example, the ground truth data may be data representing objects and object labels.

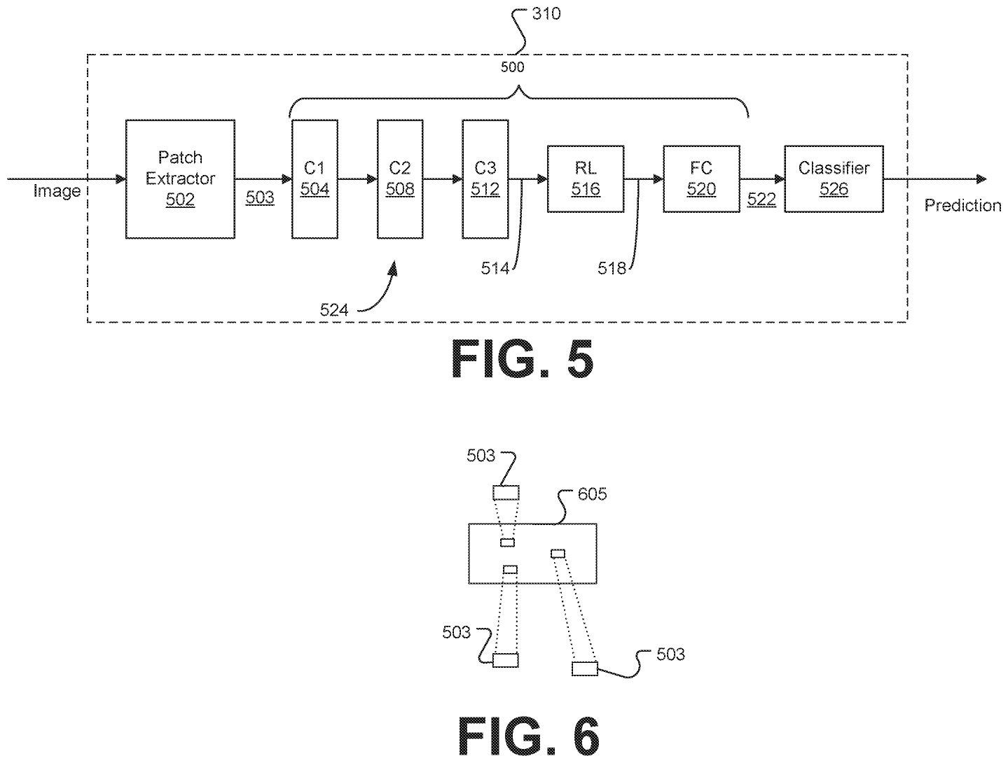

FIG. 5 is a block diagram illustrating an example implementation of the discriminator 310. The discriminator 310 includes a patch extractor 502, a capsule network 500, and a classifier 524. As shown, the discriminator 310 receives an image. The image may be the image generated by the generator 305 or an image selected from a real data distribution. The patch extractor 502 receives the image and generates one or more image patches 503 using the input image. For instance, the patch extractor 502 outputs multiple N×N image patches 503 of the input image, where N is an integer greater than 0. The patch size of the image patches 503 comprises a hyperparameter that is tuned using a validation set during training. FIG. 6 illustrates an example image 605 having a plurality of image patches 503. In an example implementation, the patch extractor 502 comprises a convolutional neural network (CNN) having one or more hidden layers such that N or the patch size is equal to the effective receptive field at the last layer of the patch extractor 502.

Referring back to FIG. 5, the image patches 503 are provided to the capsule network 500. The capsule network 500 is configured to compute a context of the image patches 503. The computed context is generated using a weighted combination of individual image patches 503 as discussed herein. The capsule network 500 is a neural network that includes capsule layers C₁ 504 (C1), C₂ 508 (C2), C₃ 512 (C3) and fully connected layers 520 (FC). The capsule network 500 receives one or more image patches 503 from the patch extractor 502. One or more image patches 503 is input to capsule layers C₁ 504 (C1), C₂ 508 (C2), C₃ 512 (C3), collectively 524, for processing. The capsule network 500 is shown with three capsule layers C₁ 504, C₂ 508, C₃ 512, however a capsule network 500 can have more or fewer capsule layers 524. The first capsule layer 504 can process an image patch 503 by applying a series of convolutional filters on input data to determine features. Features are output from first capsule layer 504 to succeeding capsule layers 508, 512 to be processed to identify features, group features, and measure properties of groups of features by creating capsules.

Intermediate results 514 output from the capsule layers 524 are input to a routing layer 516 (RL). The routing layer 516 is used when training a capsule network 500 and passes intermediate results 514 onto fully connected layers 520 at both training and run time for further processing. The routing layer 516 forms routes, or connections between capsule layers 524 based on backpropagation of reward functions determined based on ground truth that is compared to state variables 522 output from fully connected layers 520. Ground truth is state variable information determined independently from state variables 522 output from fully connected layers 520.

The computer 510 and/or the server 145 can compare state variables 522 output from capsule network 500 and back propagated with ground truth state variables to form a result function while training capsule network 500. The result function is used to select weights or parameters corresponding to filters for capsule layer 524 wherein filter weights that produce positive results as determined by the reward function. Capsule networks perform data aggregation of filter weights by forming routes or connections between capsule layers 524 based on capsules, wherein a capsule is an n-tuple of n data items that includes as one data item a location in the capsule layer 524 and as another data item a reward function corresponding to the location. In the routing layer 516, a for-loop goes through several iterations to dynamically calculate a set of routing coefficients that link lower-layer capsules (i.e., the inputs to the routing layer) to higher-layer capsules (i.e., the outputs of the routing layer). The second intermediate results 518 output from the routing layer 516 is then sent to fully connected layers 520 of the network for further processing. Additional routing layers can exist in the rest of the capsule network 500 as well.

The second intermediate results 518 output by the routing layer 516 is input to the fully connected layers 520. The fully connected layers 520 can input second intermediate results 518 and output state variables 522 representing a context of individual image patches 503. The context of an image patch may be referred to as an agreement. The state variables 522 are output to the classifier 526, which generates a prediction indicative of whether the state variables 522 correspond to a synthetic image or an image sourced from a real data distribution.

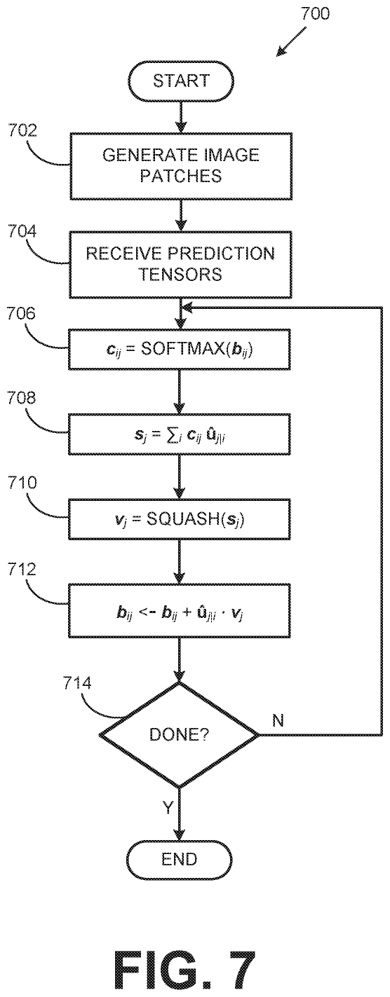

FIG. 7 is a flowchart illustrating an example process 700 for computing a context of image patches, e.g., computing a weighted combination of individual image patches 503. Process 700 can be implemented by a processor of computer 110 and/or server 145, taking as input one or more images. The images may be synthetic images generated by a generator or images sourced from a real distribution. Process 700 includes multiple blocks taken in the disclosed order. Process 700 could alternatively or additionally include fewer blocks or can include the blocks taken in different orders.

At block 702, one or more image patches 503 are generated from a received image. The image patches can be based on a kernel (filter) size, a stride parameter, and/or a padding parameter.

At block 704, the process 700 takes as input a set of prediction tensors, û_{j|i}, the number of times to perform the routing, r, and the network layer number, l. The prediction tensors û_{j|i} are calculated from the input image patches. Parent-layer capsule tensors vⱼ are defined by equation (2), below, and routing coefficients cᵢⱼ are used to select a route having a maximal value, i.e., the most optimal connection between the child and parent capsule layers. Process 700 is repeated a user input number of times per image patch for a plurality of input image patches with corresponding ground truth data when training a capsule network 700. Numbers used herein to describe a size of tensors are examples and can be made larger or smaller without changing the techniques.

For example, a single prediction tensor dimension (16, 1152, 10). The first number, 16, denotes the dimension of a single prediction vector, wherein a single prediction vector is a vector with 16 components wherein each component corresponds to a specific aspect of an object. The second number, 1152, denotes the maximum number of capsules i in layer l that can be assigned to each of the 10 capsules, j, in layer l+1. Each lower-layer capsule i is responsible for linking a single prediction vector to a parent-layer capsule j. The prediction vectors are learned by the network at training time and correspond to objects as determined by the network given a set of features. The parent-layer capsules j correspond to the object as a whole. Throughout the routing algorithm, the routing coefficients are iteratively calculated to connect lower-layer capsules with the correct higher-layer capsules. With each new image that the network sees, these calculations are performed from scratch between each of the 1152 lower-layer capsules i, and each of the 10 higher-layer capsules j, for each layer l. A tensor bᵢⱼ is initialized to zero and the iteration number k is initialized to 1.

At block 706, a Softmax operation according to equation (1), is applied to a tensor bᵢⱼ to determine routing coefficients cᵢⱼ:

$${c}_{ij} = \frac{exp ( {b}_{ij} )}{{\sum }_{k} exp ( {b}_{ij} )} \qquad ( 1 )$$

The Softmax operation converts the initial values of tensor bᵢⱼ to numbers between 0 and 1. The Softmax operation is an example normalization technique used herein, however, other scale-invariant normalization functions can be used advantageously with techniques described herein.

At block 708, the routing coefficients cᵢⱼ are multiplied with each of the prediction vectors and summed to form a matrix sᵢⱼ=Σᵢcᵢⱼû_{j|i}.

At block 710 the matrix sᵢⱼ is squashed with equation (2) to form output parent-level capsule tensors vⱼ:

$${v}_{j} = \frac{{‖ {s}_{j} ‖}^{2} {s}_{j}}{1 + {‖ {s}_{j} ‖}^{2} ‖ {s}_{j} ‖} \qquad ( 2 )$$

Squashing ensures that length of each of the rows in vⱼ is constrained to be between zero and one.

At block 712, when the iteration number k is greater than one, the routing coefficients cᵢⱼ of the matrix sᵢⱼ are updated by forming the dot product between the prediction vectors û_{j|i} and the parent layer capsule tensors vⱼ and adding the result to tensor bᵢⱼ. For example, the process 700 computes an agreement between a first image patch 503 and a second image patch 503, which is indicative of whether the image patches are located in the same general area of the image, e.g., the image patches represent the sky, etc. The agreement comprises the scalar product of vⱼ*û_{j|i}. The agreement comprises a calculation of the likelihood that a certain prediction vector is correct based on the agreement between the prediction vector and the other prediction vectors for a given parent capsule.

At block 714, the process 700 increments the iteration number and compares it to j. If the iteration number is less than or equal to j, process 700 returns to block 706 for another iteration. If the iteration number is greater than j, process 700 ends.

The process 700 is a technique for determining which capsule routes are most likely to correspond to successful operation of capsule network 500, e.g., outputting state variables 522 that match ground truth data. Fast routing is implemented during inference when the routing of capsule determined in this fashion can be discarded following training, because the routing weights can be saved during training. In use, capsule network 500 can operate based on the saved routing weights and arrive at correct output state variable 522 without individually determining capsule routes as these have been saved during process 700 during training.

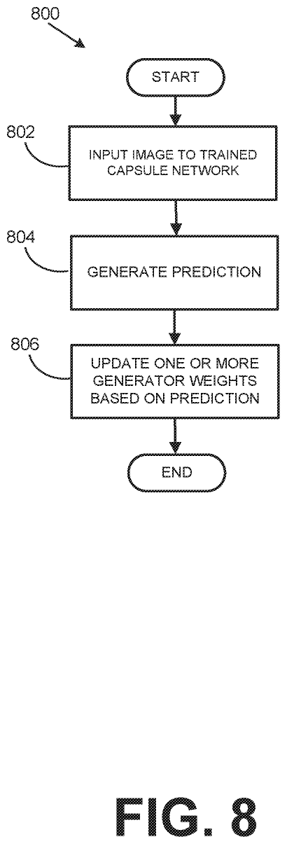

FIG. 8 is a diagram of a flowchart, described in relation to FIGS. 1 through 7, of a process 800 for generating a prediction of whether the input image is a synthetic image or an image sourced from a real distribution. Process 800 can be implemented by a processor of the computer 110 and/or a processor of the server 145. The process 800 includes multiple blocks taken in the disclosed order. The process 800 could alternatively or additionally include fewer blocks or can include the blocks taken in different orders.

Process 800 begins at block 802 where an input image is input to a trained capsule network 500. In one or more implementations, the input image is generated by a generator, such as the generator 305. The capsule network 500 has been trained using master routing coefficient tensors as described above. The capsule network 500 can output state variables 522 representing a weighted combination of individual image patches 503.

At block 804, the classifier 526 generates a prediction indicating whether the weighted combination of individual image patches 503, e.g., the output state variables 522, indicate the corresponding image is synthetic or sourced from a real data distribution. At block 806, one or more weights of the generator are updated based on the prediction. For example, the generator can use the prediction to modify one or more weights of the generator such that the generator is trained to generate photorealistic synthetic images. Once trained, the generator can generate photorealistic synthetic images that are used in downstream perception tasks. Following block 806, the process 800 ends.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OSX and iOS operating systems distributed by Apple Inc. of Cupertino, Calif., the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computers and computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random-access memory, etc.

Memory may include a computer-readable medium (also referred to as a processor-readable medium) that includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random-access memory (DRAM), which typically constitutes a main memory. Such instructions may be transmitted by one or more transmission media, including coaxial cables, copper wire and fiber optics, including the wires that comprise a system bus coupled to a processor of an ECU. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the media, processes, systems, methods, heuristics, etc. described herein, it should be understood that, although the steps of such processes, etc. have been described as occurring according to a certain ordered sequence, such processes may be practiced with the described steps performed in an order other than the order described herein. It further should be understood that certain steps may be performed simultaneously, that other steps may be added, or that certain steps described herein may be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A system comprising a computer including a processor and a memory, the memory including instructions such that the processor is programmed to:
generate, at a discriminator, a plurality of image patches from an image;
determine a plurality of routing coefficients within a capsule network based on the plurality of image patches;
generate a prediction indicating whether the image is synthetic or sourced from a real distribution based on the plurality of routing coefficients; and
update one or more weights of a generator based on the prediction, wherein the generator is connected to the discriminator.

2. The system of claim 1, wherein the image is generated by the generator.

3. The system of claim 2, wherein the image is based on a simulated image.

4. The system of claim 3, wherein the simulated image is generated by a gaming engine.

5. The system of claim 3, wherein the simulated image depicts a plurality of objects.

6. The system of claim 5, wherein the image depicts the plurality of objects corresponding to an image view of the simulated image.

7. The system of claim 1, wherein each routing coefficient of the plurality of routing coefficients corresponds to routes between capsule layers of the capsule network.

8. A system comprising a computer including a processor and a memory, the memory including instructions such that the processor is programmed to:
generate, at a discriminator, a plurality of image patches from a synthetic image;
determine a plurality of routing coefficients within a capsule network based on the plurality of image patches;
generate a predicition indicating whether the synthetic image is synthetic or sourced from a real distribution based on the plurality of routing coefficients; and
update one or more weights of a generator based on the prediction, wherein the generator is connected to the discriminator.

9. The system of claim 8, wherein the synthetic image is generated by the generator.

10. The system of claim 9, wherein the synthetic image is based on a simulated image.

11. The system of claim 10, wherein the simulated image is generated by a gaming engine.

12. The system of claim 10, wherein the simulated image depicts a plurality of objects.

13. The system of claim 12, wherein the image depicts the plurality of objects corresponding to an image view of the simulated image.

14. The system of claim 8, wherein each routing coefficient of the plurality of routing coefficients corresponds to routes between capsule layers of the capsule network.

15. A method comprising:
generating, at a discriminator, a plurality of image patches from an image;
determining a plurality of routing coefficients within a capsule network based on the plurality of image patches;
generating a prediction indicating whether the image is synthetic or sourced from a real distribution based on the plurality of routing coefficients; and
updating one or more weights of a generator based on the prediction, wherein the generator is connected to the discriminator.

16. The method of claim 15, further comprising generating the image at the generator.

17. The method of claim 16, wherein the image is based on a simulated image.

18. The method of claim 17, wherein the simulated image is generated by a gaming engine.

19. The method of claim 17, wherein the simulated image depicts a plurality of objects.

20. The method of claim 15, wherein each routing coefficient of the plurality of routing coefficients corresponds to routes between capsule layers of the capsule network.
